(19) United States
(12) Patent Application Publication
(10) Pub. No.: US 2008/0282762 A1
(43) Pub. Date: Nov. 20, 2008

(54) Tool with connector locator

(75) Inventors: Michael Rzasa, Nashua, NH (US); Jennifer M. Peterson, Epping, NH (US)

Correspondence Address: HARRINGTON & SMITH, PC, 4 RESEARCH DRIVE, SHELTON, CT, 06484-6212, US

(73) Assignee: FCI Americas Technology, Inc.

(21) Appl. No.: 11/804,383

(22) Filed: May 18, 2007

(51) Int. Cl. H01R 13/58

(52) U.S. Cl. 72/412; 29/592; 439/455; 72/416; 72/453.18

(57) ABSTRACT

An electrical connector crimping tool head including a frame, a ram and a connector locator. The frame includes a first mounting area adapted to removably receive a first connector crimping die. The ram is movably connected to the frame. The ram includes a second mounting area adapted to removably receive a second connector crimping die. The connector locator is on the frame and is adapted to indicate proper positioning of an electrical connector relative to the frame for subsequent crimping by the first and second connector crimping dies.

### BACKGROUND OF THE INVENTION

1. Field of the Invention

The invention relates to a compression tool and, more particularly, to a work piece locator on a compression tool.

2. Brief Description of Prior Developments

Compression tools, such as hydraulic crimping and cutting tools, are well known in the art. An optical system for distance measurements of a ram, such as using a laser, is also known in the art. It is also know to use a laser line in a wood cutting tool, such as a saw.

There is a desire to provide more accurate crimps of electrical connectors in electrical connector crimping tools. There is also a desire to reduce risk of injury to an operator of a hydraulic crimping tool by accurately indicating where crimping will occur on an electrical connector being crimped.

### SUMMARY OF THE INVENTION

In accordance with one aspect of the invention, an electrical connector crimping tool head is provided including a frame, a ram and a connector locator. The frame includes a first mounting area adapted to removably receive a first connector crimping die. The ram is movably connected to the frame. The ram includes a second mounting area adapted to removably receive a second connector crimping die. The connector locator is on the frame and is adapted to indicate proper positioning of an electrical connector relative to the frame for subsequent crimping by the first and second connector crimping dies.

In accordance with another aspect of the invention, a hydraulic compression tool is provided comprising a frame including an anvil section; a ram movably connected to the frame; a hydraulic drive system connected to the frame adapted to move the ram; and a laser locator connected to the frame. The laser locator is adapted to indicate a work piece positioning location between the anvil section and the ram.

In accordance with another aspect of the invention, a method of manufacturing a hydraulic tool crimping head is provided comprising providing a working head frame having a general C shape with a first mounting area adapted to removably receive a first connector crimping die; connecting a ram to the frame, wherein the ram comprises a second mounting area adapted to removably receive a second connector crimping die; and connecting a position indicator on the frame for signaling a user of an electrical connector positioning location between the first and second connector crimping dies, wherein the position indicator comprises a laser.

In accordance with another aspect of the invention, an electrical connector is provided comprising a first compression connector section adapted to be crimped onto an electrical conductor; and a light reference indicia adapted to indicate location of the electrical connector relative to generated light of a positioning system of a crimping tool for proper positioning of the electrical connector in the crimping tool.

### BRIEF DESCRIPTION OF THE DRAWINGS

The foregoing aspects and other features of the invention are explained in the following description, taken in connection with the accompanying drawings, wherein:

FIG. 1 is a perspective view of a tool comprising features of the invention;

FIG. 2 is a perspective view of the tool shown in FIG. 1 from a different direction;

FIG. 3 is an enlarged view of the working head of the tool shown in FIG. 1;

FIG. 4 is a plan top side view of the working head shown in FIG. 3;

FIG. 5 is an elevational view of a portion of an electrical connector to be crimped with the tool shown in FIG. 1;

FIG. 6 is an elevational view of a portion of an alternate embodiment of an electrical connector to be crimped with the tool shown in FIG. 1;

FIG. 7 is a side view of a working head of an alternate embodiment of the tool shown in FIG. 1;

FIG. 8 is a side view of a working head of another alternate embodiment of the tool shown in FIG. 1;

FIG. 9 is diagram illustrating components of the tool shown in FIG. 1;

FIG. 10 is a side view of the working head of another alternate embodiment of the tool shown in FIG. 1; and

FIG. 11 is a top side view of the working head shown in FIG. 10.

### DETAILED DESCRIPTION OF THE PREFERRED EMBODIMENTS

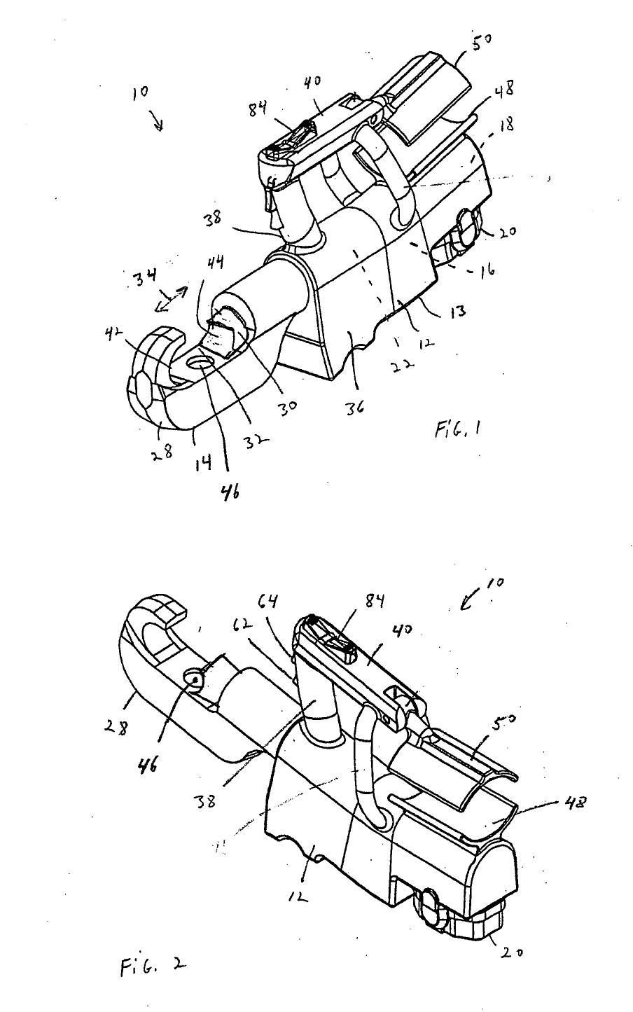

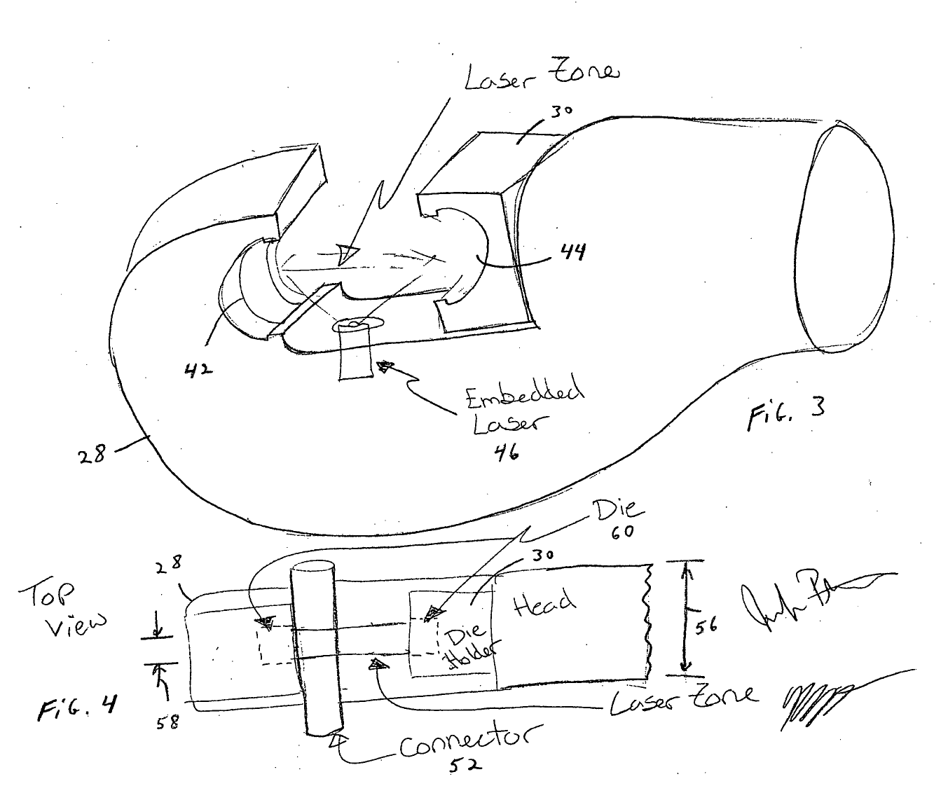

Referring to FIGS. 1 and 2, there are shown perspective views of a hydraulic tool 10 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

The tool 10 is a crimping tool for crimping an electrical connector onto an electrical conductor. However, features of the invention could be used in any suitable type of tool including, for example, a hydraulic cutting tool or a non-hydraulic tool. The tool 10 generally comprises a frame 12 which can include an outer housing 13, a working head 14, a pump 16, a motor 18, a battery 20 and a fluid reservoir 22. In one type of embodiment the tool could comprise a controller, such as a printed circuit board having a microprocessor and a memory. In alternate embodiments, the tool could comprise additional or alternative components.

The frame 12 forms a ram hydraulic drive conduit system. The working head 14 comprises a frame member 28 and a ram 30. The frame member 28 is stationarily connected to the front end of the frame 12, but could be rotatable. The ram 30 is movably connected to the member 28. In the exemplary embodiment shown, the member 28 and the ram 30 are adapted to removably receive conductor crimping dies (not shown in FIGS. 1 and 2) at a connector/conductor receiving area 32.

The crimping dies are adapted to be removably mounted to the frame member 28 and the ram 30 at opposing locations 42, 44. The two locations 42, 44 form die mounting areas of the tool 10 for removably mounting the dies to the tool. However, features of the invention could be used in a die-less tool where the tool has permanent crimping surfaces for example. Features of the invention could also be used in a non-battery operated tool or a non-hydraulic tool.

The frame 12 forms a main section 36. The battery 20 is removably connected to the bottom rear of the main section 36. However, in alternate embodiments, the frame 12 could comprise different types of shapes. In addition, the battery 20 could be removably mounted to any suitable position on the frame. The battery 20 might also be fixedly mounted to the tool and not be removable. The battery 20 is preferably a rechargeable battery.

The motor 18 is connected to the battery 20, such as via the controller or a relay controlled by the controller. The motor 18 is adapted to operate at a nominal voltage corresponding to the voltage of the battery 20. The output shaft of the motor 18 is connected to the pump 16 by a gear reduction or gearbox. Any suitable type of gear reduction assembly could be provided.

The ram 30 is adapted to move forward and backward as indicated by arrow 34. The ram hydraulic drive conduit system is connected between the pump 16 and the rear end of the ram 30. Hydraulic fluid pumped by the pump 16 against the rear end of the ram 30 causes the ram 30 to move forward. The tool 10 preferably comprises a spring (not shown) which is adapted, as is known in the art, to return the ram 30 to its reward home position when hydraulic fluid pressure is released.

The ram 30 is located at the front of the main section 36. The pump 16, fluid reservoir 22, hydraulic fluid conduit system, and motor 18 are all located in the main section 36. In order to hold the tool 10 and operate the tool with a single hand of a user, the frame 12 has a first handle section 38 and a second handle section 40.

In this exemplary embodiment, the second handle section 40 and the main section 36 comprise opposing forearm supports 48, 50. The forearm supports 48, 50 are provided to add extra support of the tool on a user's arm while the user is grasping the front handle section 38 in the “glove” type of holding configuration. More specifically, the user inserts his or her hand and forearm between the forearm supports 48, 50, and between the opposite side supports, to a location between the second handle 40 and the main section 36. The user can then grasp the first handle section 38 from behind. Thus, the user's hand is inserted into the tool similar to a glove. Alternatively, the forearm supports might not be provided.

A first user control 54 is located at the front of the first handle section 38. The first user control 54 comprises a first pump activation control switch and a first hydraulic drive system drain control switch. The first user control 54 has a first depressible trigger 62 for actuating the first pump activation control switch. The first user control 54 also has a second depressible trigger 64 for actuating the first drain control switch. The first trigger 62 can be depressed by a user to actuate the motor 18, and thus actuate the pump 16. Thus, the first pump activation control switch can be connected between the battery 20 and the motor 18, or merely to the controller (not shown) or relay.

The second trigger 64 can be depressed by a user to activate the first drain control switch. The first drain control switch is adapted to send a signal which is used to open the release valve. More specifically, the release valve is movable located in a channel of the hydraulic conduit system of the frame 12. For example, the release valve could be a combined relief and release valve similar to that disclosed in U.S. Pat. No. 4,947,672 for example, which is hereby incorporated by reference in its entirety. The release valve is normally biased in a closed position by a spring. The tool comprises a system to move the release valve to an open position. The system, in this exemplary embodiment, comprises a drain valve member and a drive. In this embodiment the drive comprises a solenoid. However, in alternate embodiments, any suitable type of drive could be provided, and any suitable connection of the drive to the release valve could be provided. For example, the drive could be an electrical motor. The drain valve member is connected to the actuator arm of the solenoid and is adapted to move the release valve to an open position when the solenoid is actuated. The spring of the release valve can return the valve to a closed position when the solenoid is de-actuated.

The second user control 56 is located at the top front of the second handle section 40. The second user control 56 comprises a second pump activation control switch and a second hydraulic drive system drain control switch. The second user control 56 has a rocker trigger or button 84 for alternatively actuating the second pump activation control switch and the second drain control switch. The front section of the rocker trigger 84 can be depressed by a user to actuate second pump activation control switch and, thus, actuate the motor 18 and pump 16. The rear section of the rocker trigger 84 can be depressed by a user to activate the second drain control switch. The second drain control switch is adapted to send a signal which can be used to open the release valve.

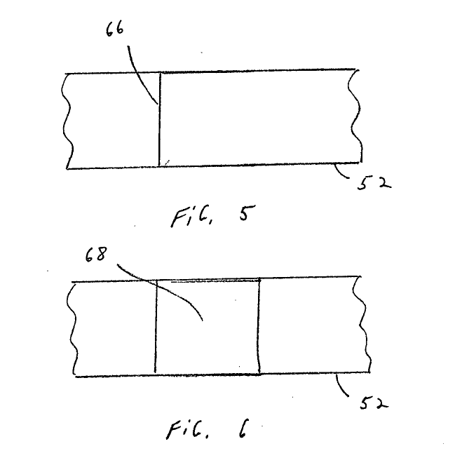

Referring also to FIGS. 3 and 4, the tool 10 includes a connector locator 46 on the frame member 28 adapted to indicate proper positioning of an electrical connector 52 relative to the frame member 28 for subsequent crimping by the first and second connector crimping dies which are mounted on the mounting areas 42, 44. In this embodiment the frame member 28 has a general C shape. However, in alternate embodiments any suitable shape could be provided. The connector locator 46, in this embodiment, comprises a laser. However, in alternate embodiments, the connector locator could comprise any suitable visible light generator, such as an LED for example.

The laser 46 is mounted in the middle section of the C shaped frame member 28; between the anvil section formed at the location 42 and the section holding the ram 30. Light from the laser 46 projects into the connector/conductor crimping area 32 between the two locations 42, 44. In one type of embodiment the laser merely generates a line between the two locations 42, 44 in the area 32. In another embodiment, the laser 46 generates a light path with a relatively wide swath between the two locations 42, 44 in the area 32; more than just a line. The connector locator or laser 46 is adapted to generate light over a limited path between the first and second mounting areas 42, 44 which is smaller than a thickness 56 of the frame member 28 at the location 32 between the first and second mounting areas 42, 44. In a swath type of light generation, this is shown by laser zone thickness 58 shown in FIG. 4.

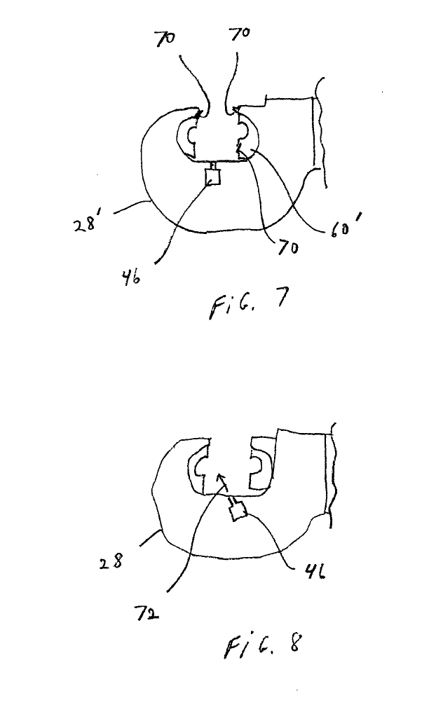

Referring also to FIGS. 5 and 6, the electrical connector 52 could comprise, for example, indicium or indicia such as line 66 or area 68 on the exterior of the connector intended to act as a system to align the connector with the light from the connector locator 46. This insures that the proper crimp area of the connector 52 is located at a proper location in the area 32 for subsequent crimping by the crimping dies 60. The indicium or indicia 66, 68 could be a visible marking or an indentation, or perhaps even printed with reactive ink, such as luminescent ink (such as when the connector locator 46 is an excitation source). For example, the ink could comprise luminescent ink such as a fluorescent ink or a phosphorescent ink.

With the invention, a laser can be added to existing tools, or existing tool designs, to indicate where the dies will interface with the work surface (the electrical connector). The laser guide can serve to create a more accurate crimp as well as reducing the risk of injury to the operator.

Referring also to FIG. 7, the die 60′ and/or the frame member 28′ and/or ram 30′ and/or the connector 52 could comprise a reflective surface 70 to insure that the user can see the alignment of the light from the connector locator 46 on the connector 52. The connector locator 46 could also be angled on the frame member 28 to angle the light path as shown by arrow 72 in FIG. 8.

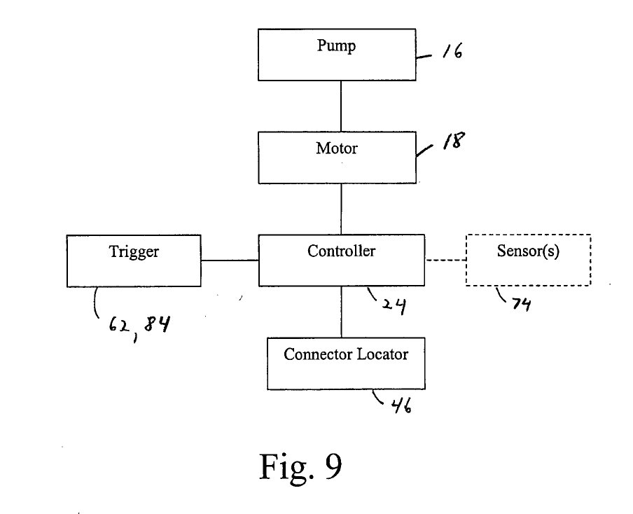

Referring also to FIG. 9, in another alternate embodiment the tool 10 can comprise one or more sensors 74 connected to the controller 24. The controller 24, besides being able to control the motor 18 when the trigger 62 or 84 is actuated, can control activation of the connector locator 46. This can help to prolong battery life by conserving activation of the connector locator 46 to only when it is needed. For example, the controller 24 can be configured to activate the connector locator 46 only when the motor 18 is ON or when the pump 16 is ON. If a sensor 74 is provided, the sensor could sense movement or location of the ram 30 to turn the connector locator 46 ON and OFF.

In an alternate embodiment, the sensor(s) 74 could additionally or alternatively sense the type of die 60 mounted in the tool and the controller 24 could change the output from the connector locator 46 based upon the sensed die. For example, for a crimping die having a relative wide crimping surface, the beam of light from the connector locator 46 could have a wide path, and for a crimping die having a relative narrow crimping surface, the beam of light from the connector locator 46 could be changed to have a narrow path or laser line shape.

In another type of embodiment, the sensor 74 could comprise a sensor for sensing reflection of light or luminescence from the connector 52. The controller 24 could be adapted to prevent operation of the motor 18 and /or pump 16 if the sensor 74 does not sense the presence of the connector in the area 32, or if the sensor 74 does not sense proper alignment of the connector 52 relative to the light from the connector locator 46.

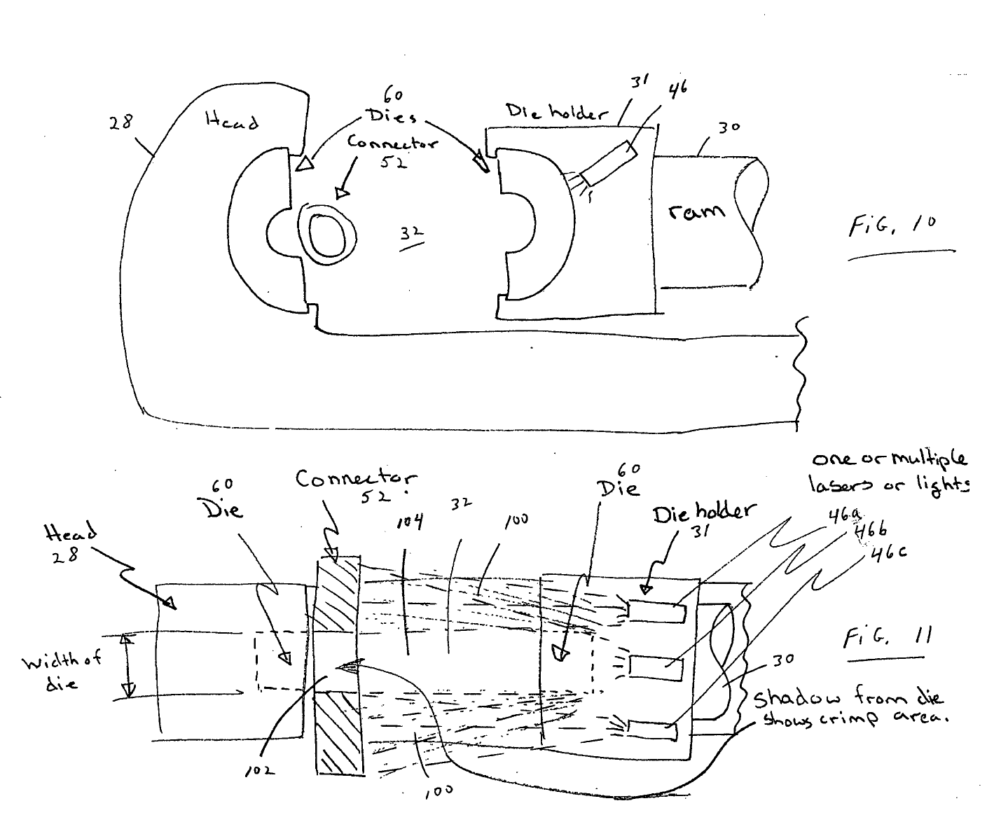

Referring also to FIGS. 10 and 11, another embodiment of the invention is shown. In this embodiment the connector locator 46 is located in the die holder portion 31 of the ram 30. The connector locator 46 comprises three lasers or light emitters 46a-46c. However, in alternate embodiments more or less that three lasers or light emitters could be provided. In additions, the lasers or light emitters could be the same or could be different from one another.

Light 100 from the emitters 46a-46c projects from behind the die 60 connected to the ram 30, and across the area 32 towards the connector 52 at the other die 60 connected to the anvil section of the frame member 28. The emitters 46a-46c are located behind the die 60 connected to the ram 30. Thus, the die 60 connected to the ram 30 blocks light from reaching the connector 52 are the crimp area 102. The user can use the contrast in illumination of the shadow area 104, created by the light blocking, versus the lighted areas 100 to locate the crimp area 102 is in a shadow area 104; and thus properly locate the crimp area 102 in the aligned position between the two dies 60 for proper crimping. Thus, with the present invention, an inverted lighting scheme can be provided with the connector 52 not being illuminated at its crimp area 102. In alternate embodiments, any suitable illumination blocking or masking could be provided for connector location indicating.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

What is claimed is:

1. An electrical connector crimping tool head comprising:
a frame comprising a first mounting area adapted to removably receive a first connector crimping die;
a ram movably connected to the frame, wherein the ram comprises a second mounting area adapted to removably receive a second connector crimping die; and
a connector locator on the frame adapted to indicate proper positioning of an electrical connector relative to the frame for subsequent crimping by the first and second connector crimping dies.

2. A crimping tool head as in claim 1 wherein the connector locator comprises a laser light generator on the frame.

3. A crimping tool head as in claim 2 wherein the frame comprises a general C shape with the laser light generator located in a middle section of the general C shape facing a crimping area between the first and second mounting areas.

4. A crimping tool head as in claim 1 wherein the connector locator comprises an visible light generator.

5. A crimping tool head as in claim 4 further comprising the first and second crimping dies connected to the frame and the ram, and wherein at least one of the dies comprises a light reflector.

6. A crimping tool head as in claim 4 further comprising a light reflector on the frame.

7. A crimping tool head as in claim 1 wherein the connector locator comprises an excitation source for exciting a luminescent material.

8. A crimping tool head as in claim 1 wherein the connector locator is adapted to generate light over a limited path between the first and second mounting areas which is smaller than a thickness of the frame at the location between the first and second mounting areas.

9. A crimping tool head as in claim 8 wherein the connector locator is adapted to generate a light line.

10. A crimping tool head as in claim 8 wherein the connector locator is adapted to generate a light swath.

11. An electrical connector crimping tool comprising:
an electrical connector crimping tool head as in claim 1;
a drive system connected to the crimping tool head to move the ram relative to the frame, wherein the drive system comprises a hydraulic pump; and
a control system for actuating the connector locator at a same time only when the hydraulic pump of the drive system is actuated.

12. An electrical connector crimping tool comprising:
an electrical connector crimping tool head as in claim 1;
a drive system connected to the crimping tool head to move the ram relative to the frame; and
a control system for sensing a type of the crimping die connected to the first and/or second mounting area, and for at least partially changing output of the connector locator based upon the sensed type of crimping die.

13. An electrical connector crimping tool comprising:
an electrical connector crimping tool head as in claim 1;
a drive system connected to the crimping tool head to move the ram relative to the frame; and
a control system for at least partially controlling the tool, wherein the control system is adapted sense a presence of the electrical connector in a crimping area between the crimping dies and control and at least partially control the tool based upon the sensed presence or absence of the electrical connector in a crimping area, wherein the control system comprises a sensor adapted to sense light from the electrical connector.

14. A hydraulic compression tool comprising:
a frame including an anvil section;
a ram movably connected to the frame;
a hydraulic drive system connected to the frame adapted to move the ram; and
a laser locator connected to the frame, wherein the laser locator is adapted to indicate a work piece positioning location between the anvil section and the ram.

15. A hydraulic compression tool as in claim 14 wherein the frame comprises a general C shaped member with the laser locator being located in a middle section of the general C shaped member facing a crimping area between the anvil section and the ram.

16. A hydraulic compression tool as in claim 14 further comprising a laser light reflector on the frame for reflecting laser light from the laser locator.

17. A hydraulic compression tool as in claim 14 wherein the laser locator is angled towards the anvil section.

18. A hydraulic compression tool as in claim 14 wherein the laser locator is adapted to generate light over a limited path between the anvil section and the ram which is smaller than a thickness of the frame at the location between the anvil section and the ram.

19. A hydraulic compression tool as in claim 14 wherein the laser locator is adapted to generate a light line.

20. A hydraulic compression tool as in claim 14 wherein the laser locator is adapted to generate a light swath.

21. A method of manufacturing a hydraulic tool crimping head comprising:
providing a working head frame having a general C shape with a first mounting area adapted to removably receive a first connector crimping die;
connecting a ram to the frame, wherein the ram comprises a second mounting area adapted to removably receive a second connector crimping die; and
connecting a position indicator on the frame for signaling a user of an electrical connector positioning location between the first and second connector crimping dies, wherein the position indicator comprises a laser.

22. A method as in claim 21 further comprising connecting the laser to a control system adapted to allow actuation of the laser only when a hydraulic pump of the tool is ON.

23. A method as in claim 21 further comprising connecting the laser to a control system having a sensor adapted to sense a type of crimping die connected to the working head frame and/or the ram and automatically change output of the laser based upon the sensed die(s).

24. An electrical connector comprising:
a first compression connector section adapted to be crimped onto an electrical conductor; and
a light reference indicia adapted to indicate location of the electrical connector relative to generated light of a positioning system of a crimping tool for proper positioning of the electrical connector in the crimping tool.

25. An electrical connector as in claim 24 wherein the indicia comprises luminescent material.

26. An electrical connector as in claim 24 wherein the indicia comprises a light reflecting surface.
